(19) United States
(12) Patent Application Publication
(10) Pub. No.: US 2007/0206000 A1
(43) Pub. Date: Sep. 6, 2007

(54) Electronic Device and a Method in an Electronic Device for Processing Image Data

(76) Inventors: Mikko Haukijärvi, Tampere (FI); Ossi Kalevo, Toijala (FI)

Correspondence Address: HARRINGTON & SMITH, PC, 4 RESEARCH DRIVE, SHELTON, CT, 06484-6212, US

(21) Appl. No.: 10/592,984

(22) PCT Filed: Mar. 15, 2005
(86) PCT No.: PCT/FI05/50080

§ 371 Date: May 11, 2007

(30) Foreign Application Priority Data
Mar. 17, 2004 (FI) 20045082

(51) Int. Cl. G06T 3/40

(52) U.S. Cl. 345/418

(57) ABSTRACT

The invention relates to an electronic device, which includes data-processing means and a memory, for performing processing on image data on the basis of blocks. The image data is arranged to be coded into unit blocks (B, MB) arranged in a preset manner, from which a processing area (PA) according to the settings can be formed from the data of one or more blocks (B, MB). For processing, data on the processing area (PA) is arranged in the memory, as well as, in a preset manner, data on the surroundings areas (EA1, EA2, EA4) of the processing area (PA), for processing the edge areas of the processing area (PA). Part of the processing area (PA1, PA2) is arranged to be formed from one or more unit blocks (MBP1-MBP3, BP1-BP5) that has been previously coded and of an area that has possibly already been at least partly processed. In addition, the invention also relates to a method and program product.

The present invention relates to an electronic device, which includes data-processing means and a memory, for performing processing on image data on the basis of blocks, in which the image data is arranged to be coded into unit blocks arranged in a preset manner, from which a processing area according to the settings can be formed from the data of one or more blocks, and, for which processing, data concerning the processing area is arranged in the memory, as well as, in a preset manner, data on the surroundings areas of the processing area, for processing the edge areas of the processing area. In addition, the invention also relates to a method and a program product.

The processing of image information of a large size and/or high resolution increases the memory requirement of electronic devices, due to the huge amount of image data involved. As is known, block-based image processing manner has been used in an attempt to resolve the problems related to the large memory requirement. Some known examples of image-coding standards that process an image from block to block include, for instance, JPEG (Joint Picture Experts Group), MPEG (Moving Picture Experts Group), H.26x, etc. Other DCT (Discrete Cosine Transform) codecs can also be included in this group. In block-based processing, the size of a unit block is usually 8×8, or 16×16 pixels. A 16×16-pixel block is generally termed a macroblock (MB).

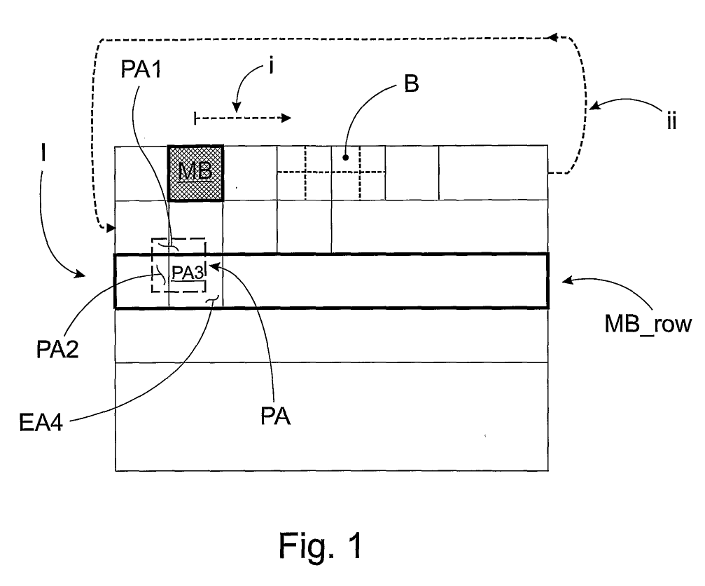

FIG. 1 shows the structure of an image frame I, when applying a macroblock-based approach. In it, each macroblock row MB_row being processed at any one time consists of one or two horizontal rows. A row includes those blocks B for the entire width of the image frame I. The macroblocks MB can have a pixel size of, for example, 16×16.

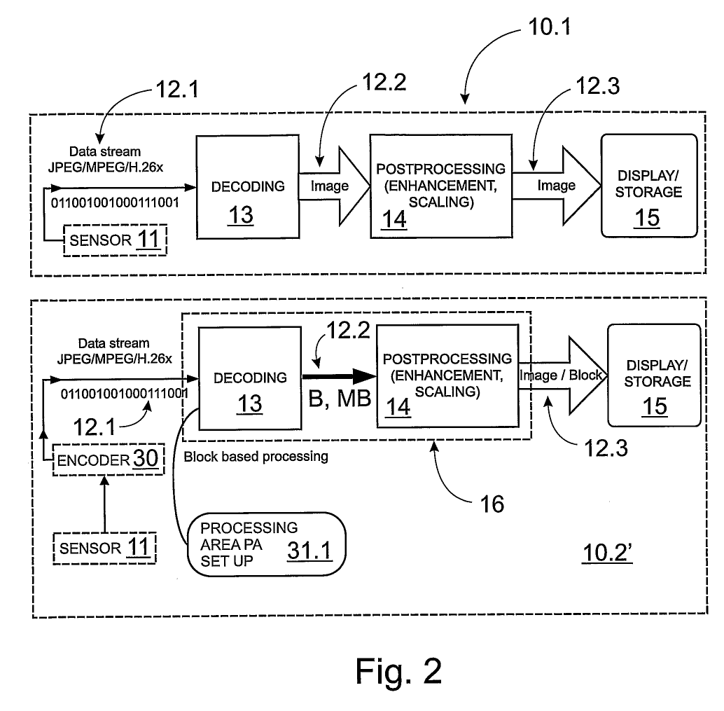

FIG. 2 shows some prior art examples in a data flowing (i.e. streaming) made through data-transfer channel, which can also be performed using blocks. The chain 10.1 in the upper part of FIG. 2 shows an image-based processing mode. The chain 10.2′ in the lower part shows block-based processing. In block-based processing 10.2′, the principle is to perform decoding, post-processing, other image-enhancement operations, and scaling on one macroblock MB at a time. This means that the block-based processing mode 10.2′ is, among other things, in order to implement real-time processing and for reducing memory consumption more recommended than, for example, the image-based mode.

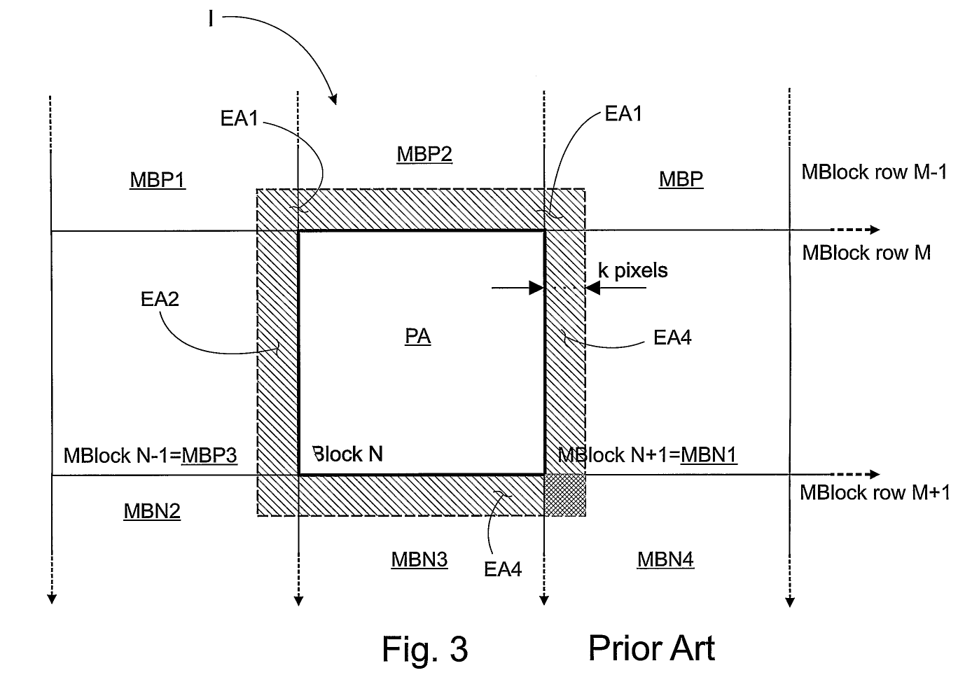

In order to modify an image point (i.e. pixel), many image-processing algorithms 14 demand certain information on the neighbourhood pixels adjacent to the image location concerned. On this basis, in order to process a specific macro block area, the image-processing algorithms 14 also require access to some of the macroblocks surrounding the image location in question. FIG. 3 shows a situation relating to this.

However, significant problems in terms of memory use relate to such processing performed according to, for example, a matrix-like, two-dimensional, unit-block division. If the areas EA1, EA2, EA4, which surround the macroblock area PA being processed, and have been selected in this manner, are taken into account, a considerable amount of memory will be required in the device 10.2′.

Some examples of such algorithms are image-enhancement algorithms. Of these, deblocking filters, for example, require information on the surroundings of the pixel point being processing at the time, to be able to detect and remove the artefact caused by blocking. Another algorithm group applying the pixel neighbourhood is image-scaling algorithms, which apply various interpolation methods.

In all block-based solutions according to the prior art, it has been the practice to process, in the working memory, an image-data area that is more extensive than the actual macroblock area being processed. This has been necessary, in order also to successfully process the edge areas of the macroblock area being in the image processed at each time. The enormous amount of image data makes this a problem.

According to a first possible solution, the entire image should be processed at one time in the working memory. However, this is in no way to be recommended in terms of memory use, due precisely to the huge amount of image data.

FIG. 3 shows an example of the area that is required to process a processing area PA of the size of a single unit block, according to the prior art (PA=macroblock N on macroblock row M). Thus, the correct complete processing of the relevant macroblock (N, M) also requires pixel information on the blocks MBPx, MBNx (the slashed area) surrounding the block area PA being processed. According to this method of defining the area, information is required even as far as block N+1 of next block row M+1 (=MBN4). Block MBN4 is now the final block, in the unit-matrix structure, which is neighbour to the actual block area PA being processed at the time (the cross-slashed area).

The above means that all the blocks following the macroblock (N, M) in the processing sequence at the time must always be decoded, up to the final neighbouring block N+1, M+1 (=MBN4). One way to perform this is to decode first the macroblock row M, corresponding to the relevant area being processed, to its end, i.e. to continue decoding to the right-hand edge of the image frame I. Next in turn is the following row M+1, from which decoding is continued, right starting from the left-hand edge of the image frame I. Decoding is continued right to block N+1 of row M+1 (=MBN4). MBN4 is thus the final block that is immediately adjacent to the area PA being processed at this time.

As can be guessed, the procedure described above demands a great deal of memory capacity in the device, especially as, depending on the processing mode, often only a few pixel rows from the neighbouring blocks MBP1-MBP3, MBP, MBN1-MBN4 are required to process the edge areas of the area PA being processed. The pixel data of the edges of the next-door neighbour blocks can also be brought to the memory, for example, one macroblock row at a time. In that case, when moving from one block being processed to the next, there is no need to always retrieve (decoding) the same edge data. However, in this case too, the consumption of memory is substantially the same.

In order to reduce memory consumption, the starting point in the case described above according to the prior art is to process at one time only part of the image area. Generally, the method used in this connection is also processing based on a macroblock row. In it, decoding, reading to working-memory, and processing are performed on a single block row at a time. In addition, a small amount of additional line memory is required to process the edges of the block rows. With reference to the above description, this requires, however, decoding of the blocks that are waiting to be processed later. The neighbouring pixel data of the previous and following block rows is stored to these additional line memories.

The general approach has been to save the information of the previously decoded and processed blocks in some temporary working memory and to then exploit this information in later processing. Usually, this means that there is a need to store the image data of a few horizontally read pixel rows. However, the data of the blocks following the area being processed at the moment, which is needed to deal with the edges of the area being processed, substantially increases the memory requirements of the block-based procedure.

The present invention is intended to create a new type of method for the block-based processing of digital image data, by means of which the edges of the area being processed can also be processed using substantially smaller memory requirements than in solutions according to the prior art. Further, the invention is also intended to create a new type of electronic device, in which the method according to the invention can be applied with reasonable memory demands, while, however, providing appropriate processing for the data. The characteristic features of the electronic device according to the invention are stated in the accompanying Claim 1 while the characteristic features of the method applied in it are stated in the accompanying Claim 9. In addition, the invention also relates to a program product, the characteristic features of which are stated in the accompanying Claim 17.

The electronic device according to the invention includes data-processing means and memory for performing selected processing operations on image data on a block basis. The image data is arranged to be coded into unit blocks arranged in a preset manner. A processing area according to the settings can be formed from the coded data of one or more unit blocks. For processing, the device's memory contains data on the processing area. In addition, the memory contains data on the surroundings of the processing area defined in a set manner, in order to process the edge areas of the processing area. In the invention, part of the processing area is arranged to be formed from one or several unit blocks that have been previously coded and possibly already at least partly processed. Using such a selection makes it possible to avoid, or at least to reduce unnecessary prior coding of the unit blocks coming after the area being processed, which, as is known, has demanded a large amount of memory capacity in the device.

Further, in the method according to the invention for the block-based processing of image data, the image data is coded into unit blocks in a set manner. A processing area according to the settings can be formed from the coded data of one or more unit blocks, for processing of that to the memory is arranged data concerning the processing area. In addition, surroundings data for the processing area is arranged in the memory in a preset manner, in order to process the edge areas of the processing area. In the method, part of the processing area is formed from one or more unit blocks that have been previously coded and at least partly already processed.

In addition, the program product according to the invention for block-based processing of image data, to which the invention thus also relates, includes code for coding image data in a set manner into unit blocks arranged as a matrix. Further, the program product includes code for forming a processing area as set, from the data of one or more unit blocks and, in addition, code for forming surroundings data of the processing area, which is arranged to be used in the processing of the edge areas of the processing area. The program product also includes code mean, by means of which part of the processing area is arranged to be formed from one or more unit blocks that have been previously coded and possibly at least partly already processed.

According to the invention, the coding can be, for example, decoding or encoding.

According to a first embodiment, the previously coded and possibly at least partly already processed unit blocks can be selected in several different ways. They can be selected, for example, only from unit-block row that has been coded and possibly already partly processed, prior to the processing of the processing area. In addition to the above, these unit blocks can also be selected from unit block column that has been coded and possibly already partly processed, prior to the processing of the processing area.

The invention permits a memory-efficient, block-based, digital-image or video-data processing model. The invention can be used particularly in applications, in which image, or video-data streams are processed. The model according to the invention is of a very general nature. It can be applied to a block or image of any size at all.

The use of the invention has significant advantages over the prior art. The invention demands hardly any pre-processing of the blocks/macroblocks of the image frame being in the processing turn at each time, but instead uses data coded in connection with the processing of previous areas. The area being processed can be coded from the data stream and can be processed immediately in the selected manner and then stored for later use. Some examples of these processing procedures are image enhancement or scaling and possible combinations of them. The processing model according to the invention is particularly suitable for applications, in which a data stream is applied.

The method has surprisingly small memory requirements. For example, in the working memory, at any one time a few line-memories of the neighbouring blocks preceding the processing area are required, as well as a small amount of memory for processing the actual processing area.

Other characteristic features of the electronic device, the method, and the program product according to the invention are apparent from the accompanying Claims while additional advantages that can be achieved are itemized in the description portion.

In the following, the invention, which is not restricted to the embodiments disclosed in the following, is examined in greater detail reference to the accompanying figures, in which

FIG. 1 shows one example of the block-based division of image data,

FIG. 2 shows some examples of the arrangement of image-data processing chains according to the prior art,

FIG. 3 shows an example of the definition, according to the prior art, of an area in block-based processing,

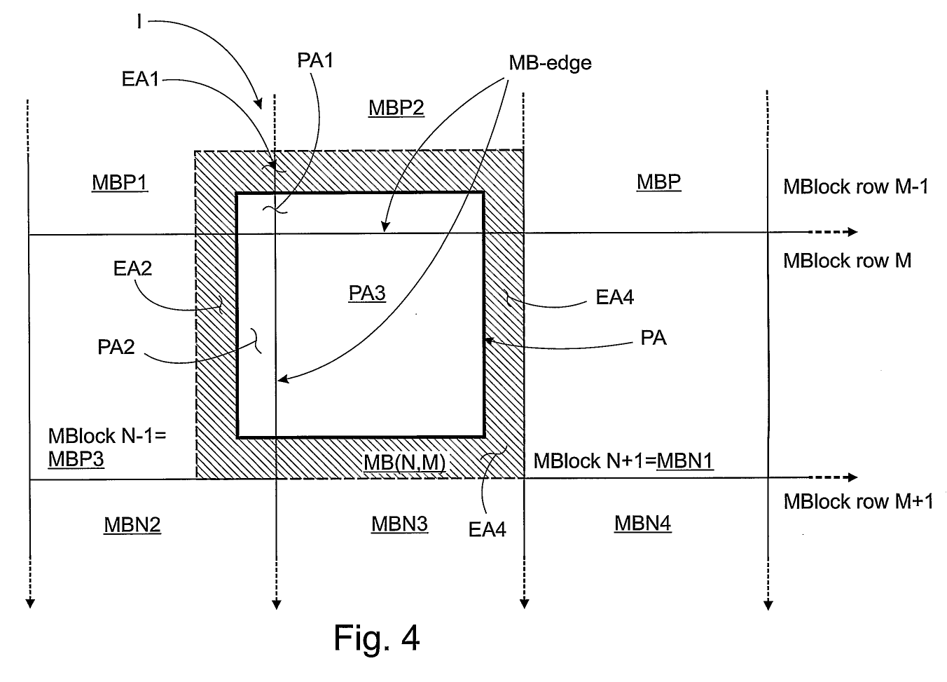

FIG. 4 shows a first embodiment of the definition, according to the invention, of a processing area in image scaling,

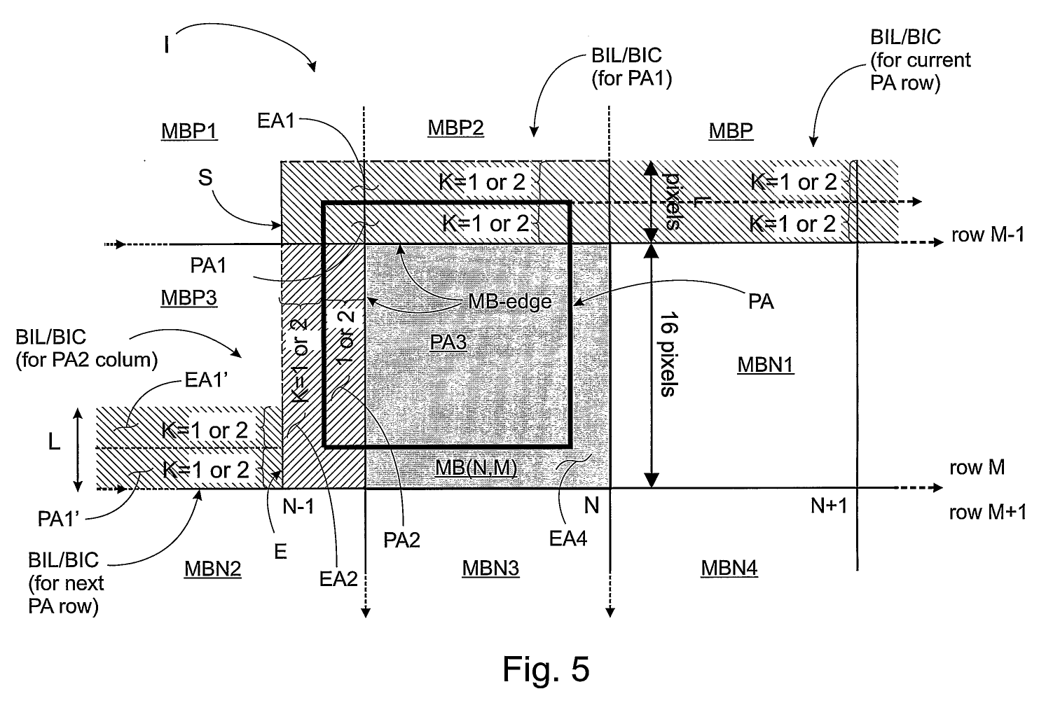

FIG. 5 shows an example of the memory requirements of the method according to the invention, in the embodiment according to FIG. 4,

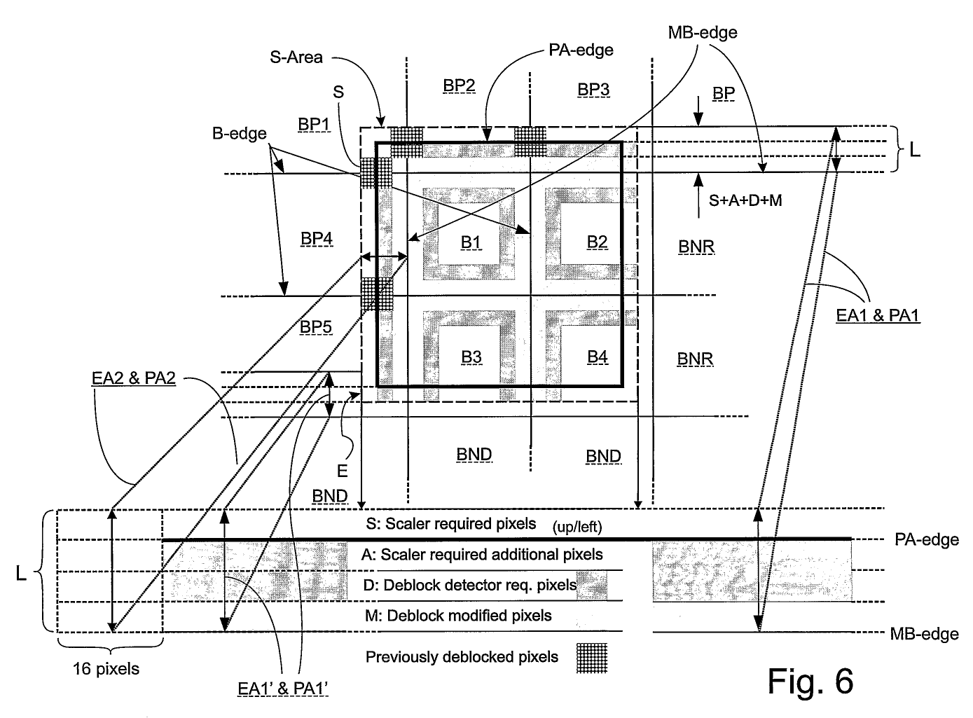

FIG. 6 shows an embodiment of the invention, when applying it to deblocking and scaling,

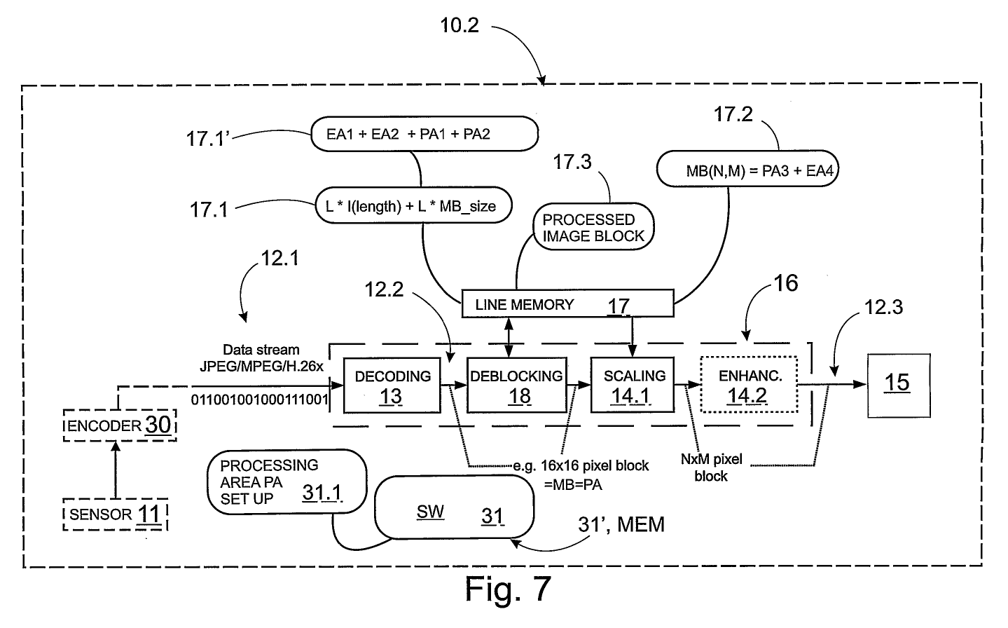

FIG. 7 shows an example of the image-processing chain in the embodiment of FIG. 6, and

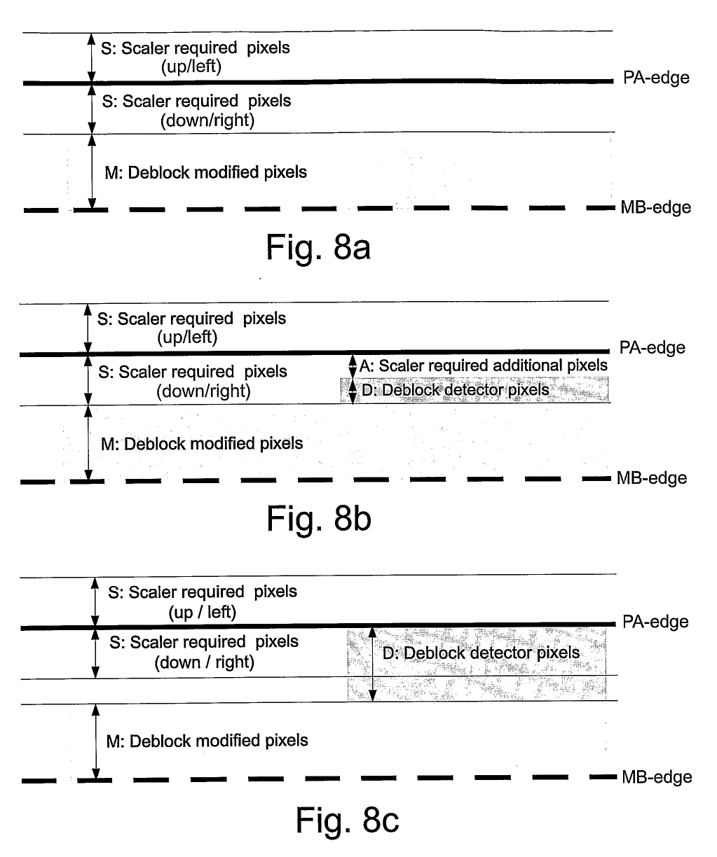

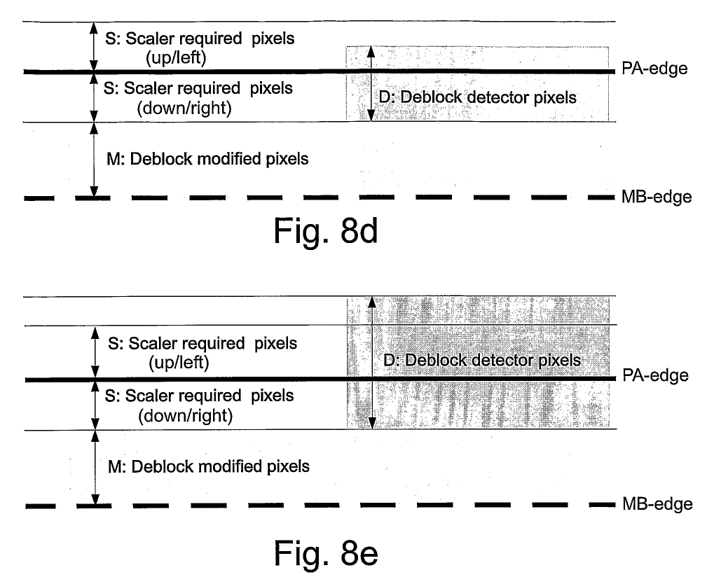

FIGS. 8a-8e show some examples of the memory requirements of the processing example according to FIG. 6.

FIG. 7 shows the most relevant components, in terms of the invention, of one example of the electronic device 10.2, in which the invention can be applied. The device 10.2 includes an image-processing chain, which can be used to process image data 12.1. The image data 12.1 can be detected, for example, using a sensor 11 belonging to the device 10.2. The image data 12.1 can also be, for example, received from a communication network. The image data 12.1 can be a digital still or video image, which is in no way restricted by the invention. Some, but in no way restrictive examples of electronic devices 10.2 to which the invention relates are mobile devices, multimedia devices, digiboxes/receivers, and digital cameras.

The electronic device 10.2 includes data-processing means 13, 14.1, 14.2, 16, 18 and a memory 17 for performing the selected processing operations on the image data 12.1 on a block basis. The data-processing means 16 can, according to one embodiment, consist of the arrangement shown in FIG. 7. In it, the decoder 13 belonging to the device 10.2 is used to decode a data stream 12.1. In this case, the decoder 13 operates on a block basis.

Prior to decoding 13, the image data 12.1 has already been encoded 30. In encoding 30, the image data produced by the sensor 11 possibly belonging to the device 10.2 is divided, by blocking it into unit blocks B, MB, in a manner dependent on the coding method. The unit blocks B, MB can be arranged in a matrix-like, two-dimensional table arrangement, as is shown in FIG. 1, for example. The encoding 30 and decoding 13 can be generally referred to as coding of the image data.

The decoder 13 puts the image data 12.1 encoded by the encoder 30 into a form that can again be processed (=i.e. it is unpacked into more or less its original form). In decoding 13, one macroblock MB at a time is decoded, and is then forwarded in the chain 16 for processing in the selected manner.

The decoder 13 is followed by the desired post-processing functionality 14. This can be the image enhancement-scaling functionality 14 shown as an example in the embodiment according to FIG. 2, to which block-based processing can also be applied. Other functionalities are also possible, as is disclosed in the later application examples.

From post-processing 14, the processed image data 12.3 is stored in an encoded form, for example, in a mass memory, displayed as such on the display 15 of the device 10.2, or can be sent to a communication network, depending on the embodiment.

FIG. 4 shows the basic principle of the invention. In the invention, depending on the processing being performed at the time, a processing area PA according to the setting is formed using the data of one or more unit blocks at least decoded already in an earlier stage. The area PA can further be envisaged as being formed of sub-areas PA1, PA2, PA3 (FIGS. 1 and 4). The macroblocks MBP1-MBP3, decoded before the macroblock MB(N, M) regarded as the actual processing area PA, can be possibly already at least partly processed of their area. The size of the area PA is defined according to the operations that will be performed. Thus, the area PA can set separately for the each processing component 18, 14.1, 14.2 of image-processing chain 16, so that even the final processing stage 14.2 can be implemented in a preferred manner according to the invention, in terms of memory use.

Decoding 13 may be always performed according to the same image-block division B, MB. The area PA is defined already before decoding of the first block of the image I is begun. After each processed block MB, the processing area PA then moves by as much as the edge of the block MB, decoded according to the set block division, would also move as processing progresses. The area PA is, as it were, a few pixel lines and columns ‘behind’ the actual block decoding, if the direction of processing is thought of as being from left to right and from up to down.

The image frame I shown as being processed in FIG. 1 can itself consist of, for example, a still image, or it can also be one frame I of a continuous video image. The information about other image frames, such as, for example, about the data of the image frame that is the previous for the image frame I being processed or the next image frame after that, the invention doesn't necessarily require at all. The processing for the image frame I being processed can be performed in turn on one area PA at a time, proceeding in the set sequence in frame I. Thus, the desired parts of the entire image frame I can be processed.

FIG. 1 shows one example of such a progression sequence. In it, in order to perform the processing of the entire image area I, a start is made, for example, from the left-hand upper corner of the image frame I. From there, processing proceeds from the left-hand edge of the image area I in the macroblock row MB_row, from column to column, to the right-hand edge, according to the set area division (the broken-line arrow i in FIG. 1). Once the processing has been completed at the right-hand edge of the frame I, the row in question has been processed. After this, the process moves downwards to the next macroblock row. Processing continues again, starting from the left-hand edge of the image area I, from the start of this next macroblock row (broken-line arrow ii). This continues, until the right-hand, lower corner of the image frame I is reached. Once the image frame I has been processed in the set manner, in the case of video data, the following image frame I+1 can be taken for processing. For that is performed the corresponding processing procedure being independent of previous image frame I. Of course, there can be other ways to proceed.

FIG. 4 shows one example of the approach of the method according to the invention, in block-based processing. In it, the processing area PA of the image frame I can be imagined as being formed of some sub-areas PA1, PA2, PA3. The area PA is the size of an individual macroblock MB. The area PA is shown as the white area remaining inside the square drawn with a thick line. Here, the perimeter areas EA1, EA2, EA4 required for processing the area PA are shown by slash.

The right-hand and lower part PA3 of the processing area PA in the image frame I is mainly formed of the last decoded macroblock MB(N,M). Thanks to the decoding of the macroblock that was performed just before, the data from the real macroblock MB(N,M) concerning the processing area PA3 is stored in the memory 17.2 of the device 10.2. Further, data of the surrounding area EA4 of the area PA3, below and to the right of the area PA3, is also stored in the memory 17.2 of the device 10.2. This area EA4 has also just been decoded, so that it is suitably available from the decoder 13. In FIG. 4, the area EA4 is bounded by the area PA3 and the macroblocks MBP2, MBN1, MBN3, and MBP3.

The sub-blocks PA1 and PA2 of the processing area PA are now formed in a surprising manner from some of the previous neighbouring blocks MBP1-MPB3 (=macroblock_previous) of the image frame I being processed. Thus data from these neighbouring blocks MBP1-MBP3 is also stored in the memory 17.1′, from their areas PA1-PA2 and their perimeter areas EA1-EA2. The storing is performed already in connection with the area processing preceding the processing of the relevant macroblock MB(N,M).

The sub-areas PA1 and PA2 located in the previous blocks MBP1-MBP3 now form part of the area PA being processed in the manner according to the invention. Further, the areas EA1 and EA2 located in the previous blocks MBP1-MBP3 consist of the upper and left-hand part of the surroundings areas remaining outside the processing area PA. In certain applications, surroundings data from the surroundings areas EA1, EA2 is required, in order to properly process the edge areas belonging to the areas PA1, PA2. The edge areas of these areas PA1, PA2 can be understood as being the pixels in the vicinity of the boundaries (the thick continuous line above and to the left) defining the processing area PA, which thus for their part belong to the area PA being processed.

According to the above, part of the actual processing area PA being processed at any time is formed of one or more unit blocks MBP1-MBP3 that have already possibly been at least partly processed and thus at least already decoded. On this basis, it is possible to use at any time, relative to the real MB(N,M) which is regarded as partly processed, only the pixels of the blocks MBP1-MBP3 preceding it. These blocks MBP1-MBP3 are already decoded in the memory 17.1 of the device 10.2. In addition, at least part of the areas of the blocks MBP1-MBP3 have possibly already been processed in connection with the previous corresponding processing areas PA.

As a result of the manner of defining the processing area PA according to the invention, there is no need to pass the real final block edge MB(N,M) in the direction of the progression of the processing, from which relevant block MB(N, M) the processing area as it's sub-area PA3 is now formed. Even more particularly, this means that the pre-decoding according to the prior art need not be performed on the blocks MBN1-MBN4 (=macroblock_next) being at the right-hand side or beneath the real block MB(N, M) being at the right-hand lower corner of the processing area PA, or even in general on any of the following macroblocks.

The unit blocks MBP1-MBP3 that for their part form the area PA1, PA2, PA3 can be selected in the invention in several different ways. According to a first simpler embodiment, the previous unit-block area PA1 can be solely a neighbouring block MBP2 found from the previous unit-block row M−1, the area of which has possibly been already at least partly processed before the processing of the (N,M) macroblock, or which has at least already been decoded. In addition, a small amount of additional data is needed from the previous macroblock row M−1, from the macroblocks MBP1, MBP2, MBP being in the surroundings of the sub-area PA1 being processed. The additional data is required to process the edge parts of the sub-area PA1 being processed. In this case, pre-coding must be performed on the block MBN1 of the macroblocks surrounding the area PA. Despite this, there is very little effect on the memory consumption of the device 10.2 compared, for example, to pre-decoding comprising all of the following blocks according to the prior art.

From the previous macroblock row M−1, an amount depending, for example, on the processing procedure or algorithm, of decoded pixel-row data of the edge areas EA1, PA1 of the blocks MBP1, MBP2, MBP is stored in the memory. In addition, pixels are required from the right-hand edge of the block MBP3, to form the area EA2. As these are the already fully decoded blocks MBP1, MBP2, MBP, the data of their lower part is already advantageously ready in the memory 17.1. This makes the processing efficient in terms of both memory use and processing time.

According to the above, the total area PA1, PA3 being processed can now be envisaged as being ‘displaced’ upwards by a set number of pixels from the real (N,M) block boundary. In that case, no ‘displacement’ to the left takes place on the same row M as the MB(N,M) macroblock that is mainly considered as being processed, as described in the embodiment of FIG. 4.

According to a second embodiment of the invention shown in FIG. 4, the unit blocks MBP1, MBP2 forming the area PA being processed which have already been previously at least decoded, and possibly also areas of which already at least partly processed, can, in addition to the previous row M−1, also be from the unit-block column N−1. This unit-block column N−1, too, is already at least decoded prior to the processing of the mainly imagined macroblock MB(N,M). In addition to the decoding, the unit-block column N−1 may also be in its area possibly already at least partly processed. The macroblock MBP3 (=N−1, M), which is the last to be decoded and processed, often immediately precedes in the block matrix I the actual macroblock area MB(N,M) that is perceived as being mainly processed, thus being also with it in the same macroblock row M.

The data relating to the macroblock MBP3 (=N−1, M), or at least the data of the edge areas EA2, PA2 of this block MBP3, is still advantageously decoded in the memory 17.1 of the device 10.2. Due to this, the processing of the macroblock MB(N, M) that is at that moment mainly regarded as being processed, and in its part also the formation of the area PA can be performed using the data of the area PA1 above the area PA and in addition the data of the area PA2 to the left of it.

The lowest horizontal pixel row and the most right-hand vertical pixel column belonging to the processing area PA are in the vicinity of the right-hand edge and lower edge of the last real block (now MB(N, M)) mainly forming the area PA now being processed, so that there is no need from the pixels of the blocks MBN1-MBN4 following the area PA to be decoded/stored either downwards or also forwards. The solution thus provides, among other things, an extremely effective arrangement for arranging the additional data required from the surroundings of the area PA.

As can be seen from FIG. 4, the block area PA1, PA2, PA3 (mainly =MB(N,M)) being processed is now a few pixels in the vertical and horizontal directions ahead of the real block area MB(N,M). It includes, however, most of the pixels of the real block area MB(N,M). The area PA is thus now seemingly ‘displaced’ by a set number of pixels both upwards and in the opposite direction to the direction of progression of the processing (the broken-line arrows i and ii of FIG. 1) from the real (N,M)-macroblock division. The ‘displacement’ depends on the processing being performed at the time.

On the basis of the above, the method involves a need to use only the pixel areas EA1, PA1, EA2, PA2 that are obtained from the areas processed immediately before the block MB(N,M) that is considered as being processed. On its one part, this area EA2, PA2 is formed from the macroblock MBP3 processed already at least partly from its area latest and thus already completely decoded. On its second part, this area EA1, PA1 is formed from the lower parts of the neighbouring macroblocks MBP1, MBP2 from the previous macroblock row M−1. Also, the row M−1 is already at least partly processed and for that purpose decoded before the processing of the row M regarded as being processed at that moment.

Further in addition, it must also be noted that, in both of the cases described above, the size of the actual area PA being processed is, however, the same as the size of the real macroblock area MB(N,M).

The invention can be used to avoid pre-processing, which demands a great deal of memory. According to the prior art, pre-processing must be performed even on the macroblocks or areas MBN1-MBN4 following the macroblock (N,M) that is regarded as being processed at the time.

The pixel data required by each processing procedure or algorithm can be stored in the temporary working memories 17.1 of the device 10.2. The amount of pixel data of the areas EA1, EA2, EA4 forming and surrounding the area PA and thus also, for its part, the ‘displacement’ of the processing area PA in the real (N,M) unit-matrix division, determines the processing algorithm or algorithms to be used at the time.

FIG. 5 shows an example of the memory requirements of the method in the electronic device 10.2. It was stated above, that the neighbourhood size of the block area PA1, PA2, PA3 being processed, and consequently the memory requirements of the method, depend largely on the processing performed on the area PA1, PA2, PA3. The following discloses, as a first example of an application, block-based image scaling, to which the method according to the invention can be applied.

In image scaling, the area PA1, PA2, PA3 refers to the image area PA that is scaled to the output image. In the application example below, scaling takes place upwards, i.e. to a larger image (higher resolution). The invention can be equally well applied to downscaling, i.e. to a lower resolution.

In scaling, selected interpolation algorithms are applied. The interpolation algorithms are based on a linear combination of input data and a specific core, which need not be described in greater detail in this connection. The interpolated pixel value can be calculated as a linear combination of the neighbouring pixels. Related to this, it is possible to apply two examples of methods. The first of these referred to is bilinear interpolation BIL and the second bicubic convolution interpolation BIC.

In bilinear interpolation BIL, four (2×2) neighbouring pixel values are used to calculate the pixel value. Thus, one pixel at the every side of the pixel being processed at the time is required from around it. In bicubic convolution interpolation, sixteen (4×4) neighbouring pixel values are required to calculate the pixel value. Thus, two consecutive pixels extending from each side around the pixel being processed are required. According to the above, when the area PA1, PA2, PA3 is, as it is here as an example, an area corresponding to the size of the macroblock MB(N,M), one or two pixel rows and columns from around it will be required (k=1, or k=2, FIG. 5). Thus, a few of the outermost pixel rows belong to the block area PA1, PA2, PA3.

The required one or two pixel rows and columns from outside the area PA1, PA2, PA3 being processed are immediately outside the area PA1, PA2, PA3 being processed. In the two pixel-row case, they can, and generally do extend essentially sequentially relative to the pixel being processed. Correspondingly, the interpolation of each pixel within the area PA1, PA2, PA3, requires, depending on the interpolation method, one or two pixels extending sequentially around the actual pixel being processed.

Because the area PA1, PA2, PA3 that is the object of the scaling processing at any time is selected in such a way that it is a set number of pixels in the direction of the unit blocks MBP1-MBP3 that have been previously at least decoded and possibly with areas already at least partly scaled, this must also be taken into account when defining the pixel rows EA1 and columns EA2 outside the (N,M) macroblocks in these directions. It should be noted that the total area PA1, PA2, PA3 is, however, still the size of the required processing area PA.

On the basis of the above, bilinear interpolation BIL requires two pixel columns EA2, PA2, and rows EA1, PA1, from the left side block areas of the macroblock area MB(N,M) considered as being mainly processed, and correspondingly also from the upper block areas MBP3, MBP1, MBP2 (BIL=1+1=2, in FIG. 5). Of these pixel rows EA1, PA1, and columns EA2, PA2, the areas PA1, PA2 closer to the area PA3 for their part form the area PA being processed. Correspondingly, the outer areas EA1, EA2 relative to the area PA3 represent the surroundings data external to the area PA, required by the scaling.

Bicubic convolution interpolation BIC requires four pixel columns EA2, PA2, and rows EA1, PA1 from the left side block areas of the macroblock area MB(N,M) considered as being mainly processed, and correspondingly also from the upper block areas MBP3, MBP1, MBP2 (BIC=2+2=4, FIG. 5) that already have been previously at least decoded and also possibly already at least partly processed. Of these pixel rows EA1, PA1, and columns EA2, PA2, the areas PA1, PA2 closer to the area PA3 form for their part the area PA being processed. Correspondingly, the two outer areas EA1, EA2 relative to the area PA3 represent the surroundings data external to the area PA, required by the scaling.

Naturally, the data for the scaling is correspondingly also required from the area EA4 outside the area PA3 and from the right-hand side area EA4, so that the pixels on the lowest edge and at the extreme right-hand edge that belong to the area PA can be properly scaled (macroblock's MB(N,M) grey area EA4 in FIG. 5). The data is needed from the lower area EA4 of the area PA3 up to the lower edge of the real MB(N,M) block boundary. The data is needed from the right-hand area EA4 of the area PA3 up to the left-hand edge of the real MB(N,M) block boundary. Because the area PA has been ‘suitably’ displaced, in the manner described above, both upwards and also to the left, the additional data required by the lower edge and right-hand edge of the area PA3 will also be taken into account, without any need for pre-coding of the blocks MBN1-MBN4 that will be scaled only later.

In bilinear interpolation BIL, the area PA1, PA2, PA3 corresponding to the size of the macroblock that is being processed at the time can thus be displaced by one pixel column, relative to the (N,M) unit-matrix macroblock division, in the direction of the macroblock area MBP3 that has been previously at least decoded and possibly already at least partly processed in its area. Correspondingly, the upwards displacement of the macroblock area PA1, PA2, PA3 being processed can also be one pixel row in the direction of the areas MBP1 and MBP2 with the aforementioned characteristics. The area PA will then be in its upper part one pixel row above the upper edge of the macroblock row M being considered as being processed. Correspondingly, the area PA will be one pixel row above the lower edge of the macroblock row M regarded as being processed.

In bicubic convolution interpolation BIC, the macroblock area PA1, PA2, PA3 that is being processed can, according to the above, be displaced by two pixel columns, relative to the (N,M) unit-matrix macroblock division, in the direction of the macroblock MBP3 that has been at least decoded previous to that and possibly already at least partly processed in its area. Correspondingly, the upwards displacement of the macroblock area PA1, PA2, PA3 being processed can also be two pixel rows in the direction of the areas MBP1 and MBP2. The area PA to be processed will then be displaced by two pixel rows, in the area MBP1, MBP2 of the macroblock row M−1 that was partly processed already in an earlier stage, being displaced now slightly above the macroblock row M that is regarded as being processed.

The necessary amount of horizontal and vertical pixel lines BIL/BIC from the previous blocks MBPx to the block PA being processed at the time, or generally areas for the processing of the area PA being processed and for its part also forming the area PA being processed, is stored in the memory 17.1 of the device 10.2. These pixel lines are shown as shaded areas in FIG. 5. Thus, data from outside the actual MB(N,M) unit block is required in the manner described above forming the edge areas PA1, PA2 of the area PA being processed and for the appropriate processing of the edge areas PA1, PA2 of the area.

When the area PA being processed is examined, the area's EA1+PA1 height is the same as L pieces of line memory. The length of the area EA1+PA1 is the width of the actual MB(N,M) macroblock (=16 pixels)+L. L is introduced, because the area PA has displaced to the left from the real (N,M) block division. Thus, L pixel columns are additionally required in the horizontal direction from the block MBP1, in order to form the areas EA1, PA1 and to process the area PA1. In other words EA1+PA1=L*(16+L).

Correspondingly, the size of the area EA2+PA2 is the height of the macroblock MB(N,M) (=16 pixels)+L pixel columns from the previous macroblock MBP3. In other words, EA2+PA2=16*L. In this scaling case L=S+S, i.e. L=1+1, or L=2+2, depending on the interpolation method applied.

These pixel lines can include first of all the pixel rows BIL/BIC. These are required at least from the block row M−1 preceding the processing area PA1, PA2, PA3, from which the required parts of the lowest pixel rows of the relevant neighbouring blocks MBP1, MBP2 are taken into account. In the case of the area PA1, the necessary rows begin, depending on the interpolation, one or two pixel columns prior to the vertical line (in FIG. 5, from point S) that defines the area PA being processed. In this case, the numbers of the pixel rows BIL/BIC (=EA1+PA1) are L=2 or 4, depending on the interpolation method.

In addition to the few pixel rows of the upper areas MBP1, MBP2 of the area PA being processed, beginning from point S, a few lowest pixel rows BIL/BIC (=EA1′, PA1′) are retained in the memory 17.1 along with the actual block MB(N,M), which is regarded as being processed at that moment, from the block MBP3 on the same line M. These rows begin from the left-hand side of the image I and thus they also include the data of the blocks to the left of the block MBP3 that have already been previously processed, as far as the boundary line E formed by the surround pixels required by the area PA being processed. It will then be observed from FIG. 5 that the boundary lines S and E are essentially on the same vertical line. In the case according to the example, the number of pixels in the memory 17.1 is formed, for this additional data row, of approximately L*the horizontal size of the image frame I in pixels.

Further, some vertical pixel columns of the block MBP3 preceding the macroblock MB(N, M), which is considered as being processed, are also stored in the working memory 17.1. These pixels (=EA2+PA2) are shown by hatching in FIG. 5. In the case of the example, the number of these pixels becomes L*16 pixels. This is because the height of the area PA being processed now corresponds to the size MB_size of the macroblock MB. A small amount of space in the memory 17.1 of the device 10.2 is also required for this area EA2+PA2.

The number of pixels required from the surrounding areas MBP1-MBP3 of the actual area MB(N,M), which is considered as being processed, thus in this case too depends on the processing algorithm being applied. The block size (macroblock-based processing) referred to above of 16×16 pixels is only intended as an example, nor is the method according to the invention in any way bound to it. Thus, any block size at all can be considered.

In addition, to the pixels required for processing the edge areas PA1, PA2 defined above, and in its part also forming the actual processing area PA, memory 17.2 will naturally also be required for the data of the sub-area PA3, for forming partly the area PA being processed, which in FIG. 5 is thus shown as a grey 16×16 area. This area PA3+EA4 is entirely suitably in the memory 17.2, as it has just been decoded. Yet other memory that is also required is, of course, the memory 17.3 intended for the result block 12.3 of the scaled macroblock PA. The size of this memory 17.3 can depend, for example, on the scaling factor. The result block 12.3 can be moved immediately after the processing of the relevant block area PA directly to the display memory, or to storage 15.

In both of the scaling procedures referred to above, the method according to the invention provides a memory-efficient way of performing the desired scaling operations.

FIG. 6 shows as a second example of an application, to which the method according to the invention can also be applied, block-based image scaling and deblocking. In the case of references of areas PA1, PA2, PA3, are referred to FIGS. 4 and 5, in which show the location of these areas within the area PA being processed. Deblocking 18 is required, because scaling is performed on the processing area PA formed from block-based data. In this case, the area PA mainly includes parts of several 8×8 blocks B1-B4. The area required by the scaler 14.1 is shown as the S-Area remaining within the square surrounded by a broken line. The area required by deblocking 18 is shown, in the case of FIG. 6, as a dark and light-grey area, which in this case includes the area PA and some pixels to the right of and below the area PA, as can easily be seen from FIG. 6.

FIG. 7 shows an example of a block diagram of the manner of implementation of post-processing, in a case according to a second embodiment. In it, deblocking 18 is performed after decoding 13, but, however, before scaling 14.1 and image enhancement. On the other hand, sometimes it may be necessary to perform only deblocking, the scaling factor being in that case 1. In this case too, scaling 14.1 is followed by possible image-enhancement processing 14.2. On the other hand, the image-enhancement processing can also precede scaling 14.1. This is because there may be fewer pixels before scaling 14.1 than after scaling 14.1, so that it will be preferable to carry out image-enhancement processing prior to scaling 14.1. It should be noted that block-based processing can also include other operations, which are not presented in this embodiment, for reasons of clarity.

If the post-processing chain 16 of the video data or image data 12.1 also includes a deblocking filter 18, the data required by the filter must then also be taken into account. It can be seen from FIG. 6, that the deblocking filter 18 may slightly increase the area around the area PA being processed required by the processing, compared to only scaling, for example. FIG. 6 shows one example of the additional pixels M, D, A required by deblocking processing. It must be noted that different scaling and deblocking methods will require different amounts of additional pixels, as can be seen in FIGS. 8a-8e. However, both forms of processing 18, 14.1 together will set the number of additional pixels required.

In this connection, it is not appropriate to describe the basic technology relating to deblocking 18 in any greater detail, instead reference can be made, for example, to the applicant's WO publication 98/41025. It discloses an adaptive filter for preventing artefacts caused by blocking.

However, in this connection enough can be said about the basic principle of deblocking to state that the filter 18 is used to remove the blocking of an image I caused by the quantification of the DCT conversion factors (i.e. artefacts). In general principle, the filter 18 acts in such a way that it modifies, for example, three pixel rows on both side of the real block edges B-edge, MB-edge. Six pixel rows on both sides of the block edge B-edge, MB-edge are needed to define the power of the filter 18 (i.e. a total of 12 pixel rows and columns). Three adjacent pixel rows M out of six pixel rows are modified on both side of the block edge B-edge, MB-edge. In addition, on each side the three following pixel rows D are used as detection pixels. These are used to detect blocking errors.

If it is intended to use bicubic convolution interpolation BIC in the scaling 14.1 of the area PA, and in the deblocking filter the applicant's deblocking 18, which is dealt with in the WO publication referred to immediately above, modified for block-based processing, pixels from the area between the boundary (MB-edge) of the macroblock area MB and the processing area PA are required, for processing the edge areas of the area MB, according to the line-memory arrangement outlined below in FIG. 6. These line-memory arrangements and their formation principles are described in greater detail later with reference to FIGS. 8a-8e. It should be noted, that this intermediate area (MB-edge−PA-edge=PA1, PA2) also follows the method according to the invention, because it is in the area PA1, PA2 of blocks BP1-BP5 that have possibly already been at least partly processed, or at least already coded in an earlier stage.

According to the above description, modified deblocking pixels M are required from the intermediate area (MB-edge−PA-edge), for example, 3 pixel rows, pixels D required by the deblocking detector are also required, for example, 3 pixel rows. In addition, possible additional pixels A required by the scaler may be yet needed, depending, for example, on the number of pixels D required by the deblocking detector. In this case the additional pixels A required by the scaler is needed to the amount A=S−D=−1<0→A=0 pixel rows. On the other side of the MB boundary MB-edge (i.e. in the area B1-B3) M- and D-pixels are correspondingly required, as in the MB-edge−PA-edge intermediate area too. Further, 2 pixel rows of pixels S, external to the area PA, demanded by the scaler 14.1, are now required, the area of which EA1, EA2 are now also in the area of the preceding blocks BP1-BP5.

In the case of the deblocking filter 18 in question, no additional pixels A required by the scaler 14.1 are needed at all from the side of area PA (A=0). This is because the deblocking filter 18 applied in the relevant embodiment requires, in addition to the area being modified (M=3 pixels), three detector pixels D and two scaling pixels S from the side of the area PA, in order to perform the actual scaling. In that case, the pixels required by the scaler 14.1 are, as it were, contained in the D-row/columns forming the areas PA1, PA2, because there can also be D-pixels in the position required by the first S. The additional pixels A required by the scaler 14.1 are needed, for example, in a such situation, in which there are not enough D-pixels to arrange the S pixels on the area PA side. In that case, the missing pixels demanded by the scaler will be these A-pixels.

The line memory requirement will be explained more graphically with reference to FIGS. 8a-8e. In these, the scaler's S up/left pixels refer to the pixels above and to the left of the PA-edge of the areas PA1 and PA2 of FIG. 6. Correspondingly, the scaler's S down/right pixels refer to the pixels below and to the right of the PA-edge of the areas PA1 and PA2 of FIG. 6. It should be noted, that in the rough drawing at the lower edge of FIG. 6 illustrating the line memory requirement, these scaler's S down/right pixels are not shown for reasons of; clarity, but they can be included in the A and D-pixel lines shown in it, depending of course on the processing algorithm used.

FIG. 8a shows a first embodiment of the line-memory arrangement according to the invention. In the case in question, a deblocking filter 18 is applied, in which, in addition to the pixels M being modified, not a single detection pixel D is required. In such a case, the number of pixels required by the scaler 14.1 is the number of pixels S required by the scaler, i.e. in this case 2+2. Thus, line memory will now be required M+S+S pixels.

FIG. 8b shows a second embodiment showing the line-memory requirement. In it, the number of detection pixels D is not 0, but some pixels (=1). The number of detection pixels D is now, however, less than S (=2), i.e. now D<S. In that case, the number of additional pixels A required by the scaler 14.1 becomes A=S−D=2−1=1 pixel. On a general level, the number of additional pixels A required by the scaler can be stated in the form A=max(0, S−D).

FIG. 8c shows a third embodiment of the line-memory arrangement according to the invention. In it, the 2 outermost detection pixels D located closest at the edge PA-edge belonging to the areas PA1 and PA2 are also available to the scaler, but the number of the required detection pixels D is, however, greater than the number of S-pixels. Because now D>S, the number of pixels then becomes M+D+S.

FIGS. 8d and 8e show a fourth and fifth embodiment relating to the line-memory requirement. In these, the memory requirement has already been compressed to be very small. In this case too, D>S. However, the manner of implementation selected depends on which of the two following cases is greater, i.e. (M+S+S) or (M+D). In the case according to FIG. 8d, S+S is greater than D, so that one additional pixel row required by the scaler remains above the D-area, the memory requirement being thus M+S+S. This additional pixel row is not now common with the pixels required in the deblocking.

FIG. 8e shows yet a fifth embodiment relating to the memory requirement. In this case, relating to the previous one, the situation D>S+S is now valid. As a result, the size of the line memory is determined solely by the deblocking filter 18. The memory requirement then becomes M+D.

At a general level, the device 10.2 requires memory 17.1 reserved for additional data amounting to approximately (M+MAX(S+S, D))×(width of image frame (I) being processed+height of processing area PA)). In addition, memory 17.2 is also required for the latest coded macroblocks MB(N,M), in which areas PA3 and PA4 are located. The horizontal size of the image (I) represent horizontal additional data, starting from the left-hand edge of the image I, as far as the right-hand edge. The PA height portion represents vertical additional data from the farthest left unit blocks B4, B5 of the (N,M) macroblock area.

When the processing progresses in the image frame I, the data stored in the line memory 17.1 can be envisaged as changing. The data changes according to the move from the area PA being processed in sequence to the next one, or to the change from, for example, one macroblock row to another. When processing is progressing, for example, in an area PA defined in the central part of an image frame I, can be imagined to be taking place in the case of FIG. 6, then the data changing can be envisaged as taking place, as it were, in the middle of the line memory 17.1, corresponding in principle, in the horizontal direction, to the location of the area PA being processed in the horizontal direction of the image I.

The M,D,S-pixel rows EA1′, PA1′, which are at the lower edge of the lowest block row B3, B4 belonging to the area PA being processed, which are introduced in the aforesaid manner, are stored in the line memory 17.1 from the macroblock row, from which the area PA being processed is formed in the manner according to the invention. In that case, the S,A,D,M pixel rows in the line memory 17.1 begin from the extreme left-hand edge of the image frame I and continue as far as the left-hand edge of the area PA being processed, or even more particularly, to the point of the area PA being processed, up to the vertical pixel line E required by the scaler and shown by a broken line. This data of the beginning of the image frame I, which is stored in the line memory 17.1, is required only in the stage, when the processing area formed from the block areas BND lying beneath the present area PA is begun to be processed. When processing the sequential processing areas on the present macroblock line, for example, the block area PA that is the subject of processing at that moment, data extending to the E point of the areas EA1′, PA1′ is thus not required.

Forwards from the end point E of the lower edge, the old pixel rows S,A,D,M, which define the upper part of the area PA being processed and which are in connection with the upper edge of the area PA, can be envisaged as being stored in the line memory 17.1. They continue as far as the right-hand edge of the image I. Thus, in the horizontal direction, these old, additional lines EA1, PA1 that were stored in the line memory 17.1 in connection with the processing of the previously processed macroblock line, are thus needed to process the area PA and partly, of course, also to form it. Further, the line memory 17.1 continues with the data of the upper part of the area PA up to the right-hand edge of image I. This data is required in the processing of the areas (for instance, BNR) following the area PA.

Correspondingly, it is also necessary to take into account the vertical area, which in this processing case is particularly near the left-hand edge of the area PA being processed, i.e. the area EA2, PA2, of the real macroblock that is considered as being processed. This data includes the short piece of the pixel-column required by the method of the invention. The size of the area EA2, PA2 is the height of the area PA being processed*the height of the SADM pixel row=MB−height*L. Together, this data forms an additional data column formed by the vertical SADM-pixel columns, which are required for forming from the sub area PA2 the block area PA being processed, and in order to take care appropriately of the left-hand sub area PA2 of the area PA in the processing case in question (=scaling and deblocking). Thus the data of the additional data column form from its part the part of the area PA2 being processed and also from its surrounding areas EA2.

When processing is performed on the block area PA, or at least at the latest after the processing of the relevant area PA, the aforementioned updating is performed in the line memory 17.1 on the data stored in it. In the changes, new additional lines from the lower edge of the point of the block area PA been processed are first of all stored in the line memory 17.1. These new lines, which can be envisaged as being moved to form a continuation to area EA1′, PA1′ starting from point E, are utilized in the processing of the block areas BND on the next row to be processed, in the manner according to the invention.

Correspondingly, the S,D,M-pixel columns at the right-hand edge of the block area PA being processed and of the real macroblock are also stored in the line memory location reserved for the vertical additional data columns EA2, PA2, in the manner according to the invention. This new ‘additional column data’, which has a size of MB-height*L, is the additional data required from the left-hand edge of the next area (BNR) to be taken for processing, in order to form the next PA's area PA2 and in order to process its edge portions (next area PA's area EA2). These aforementioned updates can be performed only once the present area PA has been processed to the point at which the data held for it in the line memory 17.1 is no longer required.

There now follows a slightly more detailed description of the arrangement of the data cycle in the line memories 17.1. After deblocking have been performed in the processing of the relevant block PA and scaling has been performed to a point at which the additional lines EA1, PA1 above are no longer required in the processing of the relevant area PA, then the area below, with a height of L, and the data area with a width of MB (the L*L area of the lower part of EA2 and PA2, and the horizontal sub-area of EA4, with a size of (16−L−S)*L) can be transferred to the memory 17.1, to the location EA1, PA1 of the upper part memory, to await the processing of the following block row (BND) at this corresponding point. The transfer should be made at the latest at the stage when the area PA has been scaled. The same should be done to the EA4 area at the right with the vertical memory of the left-hand side area, at the stage at which the memory of the left-hand side area EA2, PA2 is no longer required (i.e. after the scaling of the block PA).

Further, it should also be noted that the area PA being processed must be exactly the same size as the macroblocks B1-B4, of which it principally consists. In addition, it should be noted that the data in the line memories is processed during processing only in the case of the M-pixels. Here, processing refers precisely only to modifying due to deblocking.

The dark and grey areas within the macroblock area PA (16×16) being processed or a corresponding unit, which in this case is now formed of several (because JPEG, therefore now four) 8×8 blocks B1-B4, depict the data required from the edge areas of each 8×8 block B1-B4, in order to perform the deblocking that has already been previously performed on them. Before the scaling of the macroblock area PA can be started, deblocking processing must be performed on the edges of the 8×8 block areas B1-B4 inside the real macroblock PA. This area starts slightly to the right of the left edge real macroblock PA and below the upper edge and also extends slightly to the right of and below the macroblock area PA, as can easily be seen from FIG. 6.

The dark-grey (detection pixels) and light-grey (modified pixels) areas of these 8×8 block areas depict the areas in the areas of this relevant macroblock's PA area, on which deblocking filtering must be performed, before scaling can be performed on the actual macroblock PA itself. In these too, on the light-grey modification pixels M are modified, the detection pixels D remaining unmodified.

The areas shown as grids of circles to the left of and above the macroblock area PA being processed are the areas of the previously processed macroblocks BP1-BP5 (i.e. in the same row and in the previous macroblock row). They have been deblocked in connection with the previously processed areas. Of these areas, the areas above the area PA being processed are transferred, through the line memories EA1, PA1 to this new macroblock area PA and, correspondingly, the areas to the left of the area PA being processed are transferred, through the additional column memories EA2, PA2, to this new macroblock area PA.

It should be noted, that, if the unit being processed will not be the macroblock PA, as it is in this embodiment, but instead a single block B, then the grey areas inside the block area PA will not be at the locations of the central blocking edges of the blocks B1-B4, but only above and to the left.

Because, in the invention, the area PA of a single image frame I being processed is defined in a surprising manner as if it were ‘displaced’ compared, for example, to the real coded blocks, it therefore creates a need for special measures, for example, in the areas most at the edges of the image frame I (if these are being processed), so that the entire image area I can be processed. More specifically, this need arises first of all from the fact that, in the first row of image I and at the left-hand edge, the processing area PA defined in the manner according to the invention is smaller, because previous data (EA1,2, PA1,2) does not exist in these areas. Correspondingly, in the last row and right-hand edge of the image I, a few pixels from below and to the right of the block being processed must be processed, which would otherwise remain unprocessed. These special areas may take care out of, for example, by programmatically.

The method according to the invention does not demand pre-processing of the image's blocks/macroblocks. Once the block has been decoded, for example, from a data stream, it can be immediately processed in the selected manner (for example, enhanced or scaled) and store for future use. Thus, the processing method according to the invention is particularly suitable for applications using datastreaming.

The method's memory requirements are small. Only a few lines of working memory 17.1 are needed for the previous blocks (M)BPx and, of course, a small amount of memory 17.2, 17.3 for the data of the block PA being processed. The program product 31′, to which the invention also relates, can be implemented using some suitable programming language, or also as a HW implementation. The program product 31′ includes one or several program codes to be implemented by processor means, including at least one code mean 31.1 in order to perform the method according to the invention in the electronic device 10.2. The code means 31.1 of the program codes 31 are stored, for example, to the storage medium. The storage medium may be, for example, the application memory/DSP of the device 10.1 in which the code mean 31.1 is integrated. The HW-level implementations are also possible.

To the block-based processing may also includes, for example, pixel-based enhancement (for example, gamma correction), which does not require additional memory.

The invention can be applied in imaging devices with a limited signal-processing power and/or a limited memory capacity, such as, for example, in camera phones, or in portable multimedia devices. The invention doesn't require information or data about image frames which are previous or next to the image frame I being processed. In the invention is processed the image data 12.1 of only one image frame I. The method is also suitable for application in systems with a data channel of limited bandwidth. The method can be applied in both the decoding and encoding stages in connection with for the image data is performed immediately, for example, one or more operations described above.

It must be understood that the above description and the related figures are only intended to illustrate the present invention. The invention is thus in no way restricted to only the embodiments disclosed or stated in the Claims, but many different variations and adaptations of the invention, which are possible within the scope on the inventive idea defined in the accompanying Claims, will be obvious to one versed in the art.

1. An electronic device, which includes data-processing means and a memory, for performing processing on image data on the basis of blocks, in which the image data is arranged to be coded into unit blocks (B, MB) arranged in a preset manner, from which a processing area (PA) according to the settings can be formed from the data of one or more blocks (B, MB), and, for which processing, data on the processing area (PA) is arranged in the memory, as well as, in a preset manner, data on the surroundings areas (EA1, EA2, EA4) of the processing area (PA), for processing the edge areas of the processing area (PA), characterized in that part of the processing area (PA1, PA2) is arranged to be formed from one or more unit blocks (MBP1-MBP3, BP1-BP5) that has been previously coded and of an area that possibly has already been at least partly processed.

2. An electronic device according to claim 1, characterized in that the said coding is encoding.

3. An electronic device according to claim 1, characterized in that the said coding is decoding.

4. An electronic device according to claim 1, characterized in that the said unit blocks (MBP2, BP2, BP3) are from a unit-block row (M−1) that possibly has already been partly processed and previously coded prior to the processing of the processing area (PA1, PA2, PA3).

5. An electronic device according to claim 1, characterized in that the said unit blocks (MBP1, MBP3, BP1, BP4, BP5) are, in addition, from a unit-block column (N−1) that possibly has already been partly processed and previously coded prior to the processing of the processing area (PA1, PA2, PA3).

6. An electronic device according to claim 1, characterized in that the data of the said unit blocks (MBP1-MBP3, BP1-BP5) that have been possibly already pro-cessed and previously coded is arranged to form in its part the processing area (PA1, PA2) and in its part the surroundings area (EA1, EA2) and the data includes a number of pixel lines (S, A, D, M) that depends on the processing operations to be performed.

7. An electronic device according to claim 1, in which the processing of the image frame (I), arranged to be performed, for example, on a macroblock-sized (MB) area (PA1, PA2, PA3), is at least deblocking and scaling, characterized in that the device has memory for processing the image frame (I), to an amount of approximately:
MB-size+Output-size
(M+MAX(S+S,D))×
(width of image frame+height of processing area).

8. An electronic device according to claim 1, characterized in that the image data is a continuous video-image stream.

9. A method for the block-based processing of image data, in which method
the image data is coded into unit blocks (B, MB) arranged in a set manner,
a processing area (PA) according to the settings is formed from the data of one or more unit blocks (B, MB),
for the processing of the image data on the processing area (PA) is collected and, in addition, in a set manner, data from the surroundings areas (EA1, EA2, EA4) of the processing area (PA), in order to process the edge areas of the processing area (PA),
characterized in that part of the processing area (PA1, PA2) is formed from one or more unit blocks (MBP1-MBP3, BP1-BP5) the area of which has already previously been coded and possibly already at least partly processed.

10. A method according to claim 9, characterized in that the said unit blocks (MBP2, BP2, BP3) are taken from a unit-block row (M−1) that possibly has already been partly processed and which has been previously coded prior to the processing of the said processing area (PA1, PA2, PA3).

11. A method according to claim 9, characterized in that the said unit blocks (MBP1, MBP3, BP1, BP4, BP5) are taken, in addition, from a unit-block column (N−1) that possibly has already been partly processed and which has been previously coded prior to the processing of the said processing area (PA1, PA2, PA3).

12. A method according to claim 9, characterized in that the data of the said already partly processed and previously coded unit blocks (MP1-MBP3, BP1-BP5) forms in its part the processing area (PA1, PA2) and in its part the surroundings area (EA1, EA2), and the data includes a number of pixel lines (S, A, D, M) that depends on the processing operations to be performed.

13. A method according to claim 9, in which the processing of the image frame (I), arranged to be performed, for example, on a macroblock-sized (MB) area (PA1, PA2, PA3), is at least deblocking and scaling, characterized in that memory for processing the image frame (I) is reserved in the device, to an amount of approximately:
MB-size+Output-size
(M+MAX(S+S,D))×
(width of image frame+height of processing area).

14. A method according to claim 9, characterized in that the image data is a continuous video-image stream.

15. A method according to claim 9, characterized in that the coding is encoding.

16. A method according to claim 9, characterized in that the coding is decoding.

17. A computer program product for the block-based processing of image data, in which the computer program product forms about memory device (MEM) and program codes arranged on the memory device (MEM), which includes
code for coding the image data into unit blocks (B, MB) arranged in a set manner,
code for forming a processing area (PA) according to the settings from the data of one or more unit blocks (B, MB), and
code for collecting data from the surroundings areas (EA1, EA2, EA4) of the processing area (PA), which is arranged to be used in the processing of the edge areas of the processing area (PA),
characterized in that the program code includes code mean by means of which part of the processing area (PA1, PA2) is arranged to be formed from one or more unit blocks (MBP1-MBP3, BP1-BP5), the area of which has already been previously coded and possibly already at least partly processed.

18. A computer program product according to claim 17, characterized in that the program code includes code mean, by means of which the said unit blocks (MBP2, BP2, BP3) are arranged to be taken from a unit-block row (M−1) that possibly has been already partly processed and previously coded.

19. A computer program product according to claim 17, characterized in that the program code includes, in addition, code mean, by means of which the said unit blocks (MBP1, MBP3, BP1, BP4) are arranged to be taken from a unit-block column (N−1) that possibly has been already partly processed and previously coded.

20. A computer program product according to claim 17, characterized in that the data of the said already partly processed and previously coded unit blocks (MBP1-MBP3, BP1-BP5) forms in its part the processing area (PA1, PA2) and in its part the surroundings area (EA1, EA2) and the said data includes a number of pixel lines (S, A, D, M) that depends on the processing operations to be performed.

21. A computer program product according to claim 17, in which the processing of the image frame (I), arranged to be performed by the computer program product, for example, on a macroblock-sized (MB) area (PA1, PA2, PA3), is at least deblocking and scaling, characterized in that the code mean of the program code is arranged to reserve memory for processing the image frame (I), to an amount of approximately:
MB-size+Output-size
(M+MAX(S+S,D))×
(width of image frame+height of processing area (MB)).

22. A computer program product according to claim 17, characterized in that the image data is a continuous video-image stream.

23. A computer program product according to claim 17, characterized in that the code for coding the image data includes encoding code.

24. A computer program product according to claim 17, characterized in that the code for coding the image data includes decoding code.

25. The use of the method according to claim 9 in the scaling of the image data.

26. The use of the method according to claim 9 in the deblocking of the image data.
